(19) United States
(12) Patent Application Publication
(10) Pub. No.: US 2003/0229585 A1
(43) Pub. Date: Dec. 11, 2003

(54) Systems and methods for marketing to existing financial account holders

(75) Inventor: Janel Butler, Chesterfield, VA (US)

Correspondence Address: Finnegan, Henderson, Farabow,, Garrett & Dunner, L.L.P., 1300 I Street, N.W., Washington, DC, 20005-3315, US

(73) Assignee: Capital One Financial Corporation

(21) Appl. No.: 10/161,642

(22) Filed: Jun. 5, 2002

(51) Int. Cl. G06F 17/60

(52) U.S. Cl. 705/39; 705/35

(57) ABSTRACT

Systems and methods are provided for marketing to an existing customer of a financial account. If, for example, a determination is made that the financial account of the customer is inactive, then one or more upgraded account term(s) are generated. The financial account with the upgraded account term(s) may be more beneficial to the customer. The customer is then notified of the upgraded account term(s). As a result, the customer may be provided with an incentive to more frequently use the existing financial account.

### BACKGROUND OF THE INVENTION

1. Field of the Invention

The present invention generally relates to managing financial accounts and, more particularly, to systems and methods for marketing to existing customers of financial accounts.

2. Description of the Related Art

Credit cards and other types of financial accounts have become so commonplace that consumers often have more than just one account. For example, many consumers apply for another credit card simply to receive more benefits, such as lower interest rates, discounts on purchases, and/or frequent flyer programs. Some consumers have multiple credit cards so they have more than just one type of card (such as MasterCard, Visa, American Express, etc.) accepted by merchants.

But no matter how many credit cards a consumer may have, the consumer is likely to use one much more than all of the others. For instance, a consumer will likely use a “most favored” card for most, if not all, of their purchase transactions, cash advances, balance transfers, and other types of account transactions. The consumer may even forget about their other credit cards entirely. Such cards may sit in the consumer's wallet, purse, or desk drawer without the

The financial institutions who issued the unused credit card, however, must still spend resources managing the unused account. In addition to the basic operating costs associated with maintaining an account for the customer, the issuer may also spend resources keeping track of the account in the issuer's accounting records. Since the account issuer realizes no profit from the consumer's lack of use of the card, such accounts represent a non-performing asset or loss to the issuer. For these reasons, account issuers will often close an account after a period of time has elapsed without the consumer having ever used the card. But by doing so, the account issuer loses a potentially valuable customer. Accordingly, there is a need for a way to increase a consumer's use of a credit card already issued to that consumer.

### SUMMARY OF THE INVENTION

Systems and methods consistent with embodiments of the present invention enable financial institutions to market to existing account holders in order to improve revenue. Systems and methods consistent with embodiments of the present invention also enable financial institutions to increase the incentive of existing customers to more frequently use their accounts, such as credit card accounts.

For example, systems and methods of the invention market to an existing customer of a financial account. If it is determined that an existing customer's financial account is inactive, then at least one upgraded account term is generated. The financial account with the upgraded account term(s) may be more beneficial to the customer. The customer is then notified of the offer for the upgraded account term(s). As a result, the customer may be provided with an incentive to more frequently use their financial account.

Both the foregoing general description and the following detailed description are exemplary and are intended to provide further explanation of the embodiments of the invention as claimed.

### BRIEF DESCRIPTION OF THE DRAWINGS

The accompanying drawings, which are incorporated in and constitute a part of this specification, illustrate various embodiments of the present invention and, together with the description, serve to explain embodiments of the invention. In the drawings:

FIG. 1 is an exemplary block diagram of a system for managing a financial account, consistent with embodiments of the present invention;

FIG. 2 shows an exemplary table containing customer selection model data, consistent with embodiments of the present invention; and

FIG. 3 is an exemplary flow chart of a method, consistent with embodiments of the present invention, for marketing to existing financial account holders.

### DETAILED DESCRIPTION

Systems and methods consistent with embodiments of the invention enable financial institutions that issue financial accounts (such as credit card accounts) to increase the incentive of existing customers to more frequently use their accounts. To this end, a determination is made whether an individual account of a customer is inactive. This determination may be made based on, for example, the account's balance or the number of account transactions over a predetermined time period. If the account is inactive, then the system determines one or more upgraded account terms to offer the customer if the customer is so eligible. An output module may then prepare a communication which notifies the customer of the offer for the upgraded account term(s). As a result, the consumer is more likely to use the financial account more frequently than before, benefiting the account issuer. If, however, the consumer does not accept the offer or the account continues to be inactive, then the account issuer may close the account since it is a non-performing asset.

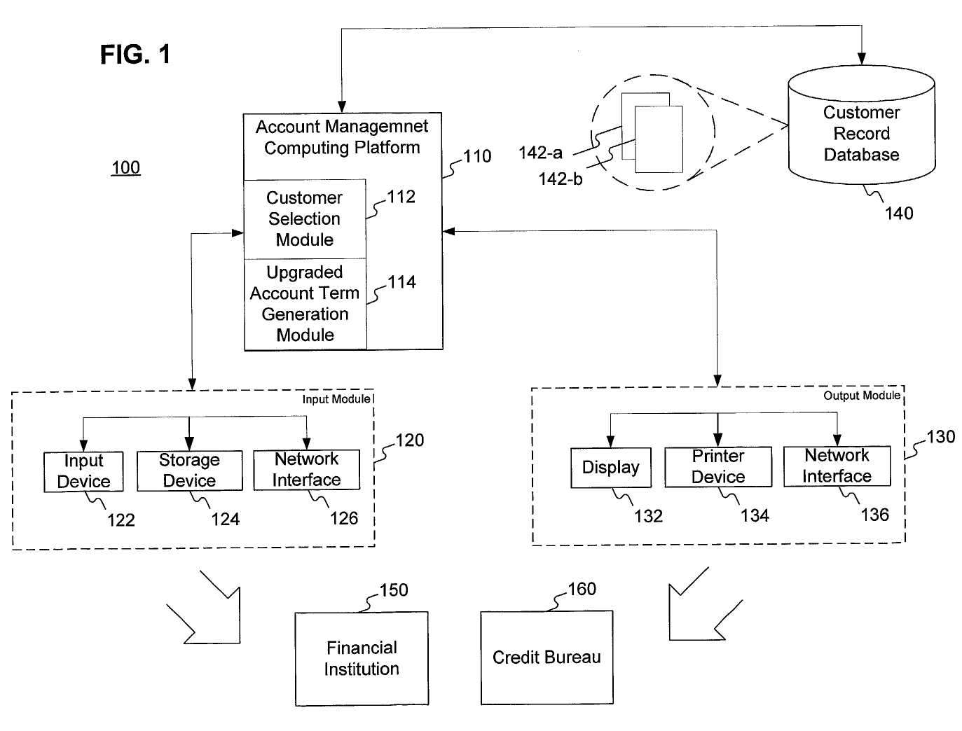

By way of a non-limiting example, FIG. 1 illustrates an exemplary system environment 100 for implementing embodiments of the present invention. As illustrated in FIG. 1, the system 100 includes a computing platform 110, an input module 120, an output module 130, and a customer record database 140. Customer record database 140 may further include customer account records 142. System 100 may also include a network connection between modules 120, 130 and a financial institution 150 or a credit bureau 160.

Computing platform 110 may comprise any computer, such as a personal computer, workstation, or mainframe computer for performing various functions and operations, consistent with embodiments of the invention. Computing platform 110 may be implemented, for example, by a general purpose computer selectively activated or reconfigured by a computer program stored in the computer, or may be a specially constructed computing platform for implementing the features and operations of the present invention. Computing platform 110 may also be implemented or provided with a wide variety of components or subsystems including, for example, one or more of the following: a central processing unit, a co-processor, memory, a data register, and other data storage and/or processing devices and subsystems.

As shown in FIG. 1, computing platform 110 may include a customer selection module 112 and an upgraded account term generation module 114. Customer selection module 112 determines which customers to select for offering one or more upgraded account terms. Account term generation module 114 generates the upgraded account terms to be offered to the customers selected by module 112. As part of the processing implemented by modules 112 and 114, computing platform 110 may process account transaction information received from input module 120 or credit bureau 160. Computing platform 110 may also provide account information to output module 130. Additionally, computing platform 110 may access information in customer record database 140 to determine customer account history information, which may then be provided to output module 130.

Input module 120 further includes an input device 122, a storage device 124, and/or a network interface 126. Input device 122 may include a keyboard, mouse, or other data entering device. Storage device 124 may include a disk drive, optical drive, CD-ROM drive, or other device for reading data stored on a storage medium. Network interface 126 may receive information (e.g., from financial institution 150 or credit bureau 160) over any type of network (not shown), such as a telephony-based network (e.g., PBX or POTS), a local area network, a wide area network, a dedicated intranet, and/or the Internet.

Input module 120 may be used to enter or obtain information about the customer, such as customer credit information, the customer's outstanding balance, and/or payments or charges made by the customer to the account. Input module 120 may also be used to obtain or enter a customer's credit history information, which may be transferred automatically from credit bureau 160 or may be entered manually. Input module 120 may forward any received customer or account information to computing platform 110 for processing and/or storage in customer record database 140.

Computing platform 110 may provide customer account information generated by computing platform 110 or obtained from customer record database 140, to output module 130. The outputted account information may include upgraded account term(s) for encouraging the customer to more often use the account. Output module 130 may output the account information to the customer or to personnel of the account issuer for use internally or for assisting the customer. Platform 110 may also output scripts (e.g., textual scripts that customer service representatives follow when talking to a customer) to module 130 that are used by customer service representatives when notifying the customer of the upgraded account terms. Further, module 130 may prepare e-mail, regular mail, or automatic telephone communications, for example, that are automatically sent to notify the customer of the upgraded account term(s).

As shown in FIG. 1, output module 130 further includes a printer device 132, a network interface 134, and/or a display device 136. Printer device 132 may be used to provide a conventional printed record. Network interface 134 may provide this information to the customer, to the financial account issuer, or to the credit bureaus 160, via any type of network as described above with respect to input module 120. Display device 136 may provide account information to a representative of the account issuer, either for assisting the customer or for forwarding to the credit bureaus 160, which may be one of the major credit bureaus, such as TRW/Experian, Equifax, and TransUnion.

Customer record database 140 stores customer account records 142. Each customer account record 142 may include an account history record, as well as other identifying information concerning the customer and the financial account. Account record 142 may thus store information about transactions and payments made by the customer with respect to the account.

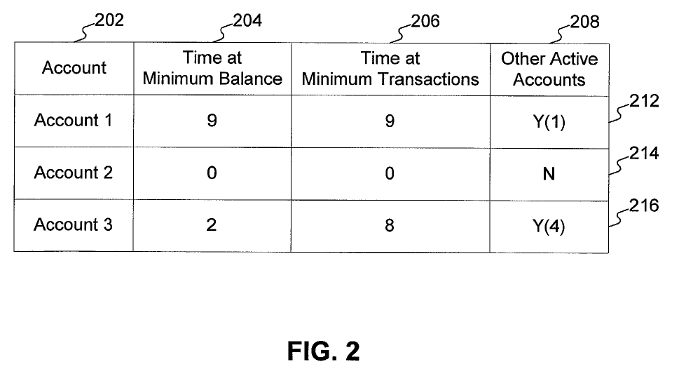

FIG. 2 shows an exemplary table containing customer selection model data, consistent with embodiments of the present invention. Table 200 may reside or be stored in a database, such as the customer record database 140 of FIG. 1. Alternatively or additionally, table 200 may be part of a relational database or any other conventional database arrangement. Table 200 may contain, for example, data generated from account history record 152 or from customer credit information received from credit bureau 160.

Consistent with embodiments of the invention, the data of table 200 may be structured or stored according to various conventional techniques or arrangements. For example, the data may be structured or stored using data strings or linked lists. Further, as illustrated in FIG. 2, table 200 may be structured to provide several rows and/or columns of information for customer accounts, such as credit card customer accounts.

As shown in FIG. 2, a column 202 may be provided in table 200 to list account numbers identifying the unique accounts of customers or users. Column 204 may include a reference to the amount of time the balance of an account was at or below a minimum value. For example, the column may identify the number of consecutive payment cycles where the balance was at or below a minimum value, or may identify the number of payment cycles within a predetermined period (e.g., the last year) where the balance was at or below a minimum value. Similarly, column 206 may include a reference to the amount of time the number of transactions over a payment cycle are at or below a minimum value during a predetermined period. Column 208 may include an identification of whether the customer has other financial accounts competing with the account identified in column 202, including the number of such accounts and/or the types of such accounts. System 100 may obtain information on a customer's other accounts from credit bureau 160. Thus, for example, where the customer does have a credit card account from another card issuer, this column may contain a “Y” and a reference to the number of such competing accounts. Finally, although not shown, other columns may include information concerning the customer's account activity, credit worthiness, or information about the customer's other competing accounts.

Each of the entries in the columns may be fields containing data representing the value of the corresponding field. Thus, for example, column 206 includes values (e.g., the number of payment cycles at which the number of account transactions was at or below a minimum threshold value) for each account. The order of the columns in table 200 is merely exemplary and, accordingly, the columns indicated in table 200 may be arranged differently, consistent with embodiments of the present invention.

As further illustrated in FIG. 2, each row of table 200 may provide information concerning the customer's account usage or credit history. Although only three accounts and their corresponding customer information is illustrated in table 200, information concerning any number of accounts may be organized and stored in a similar fashion.

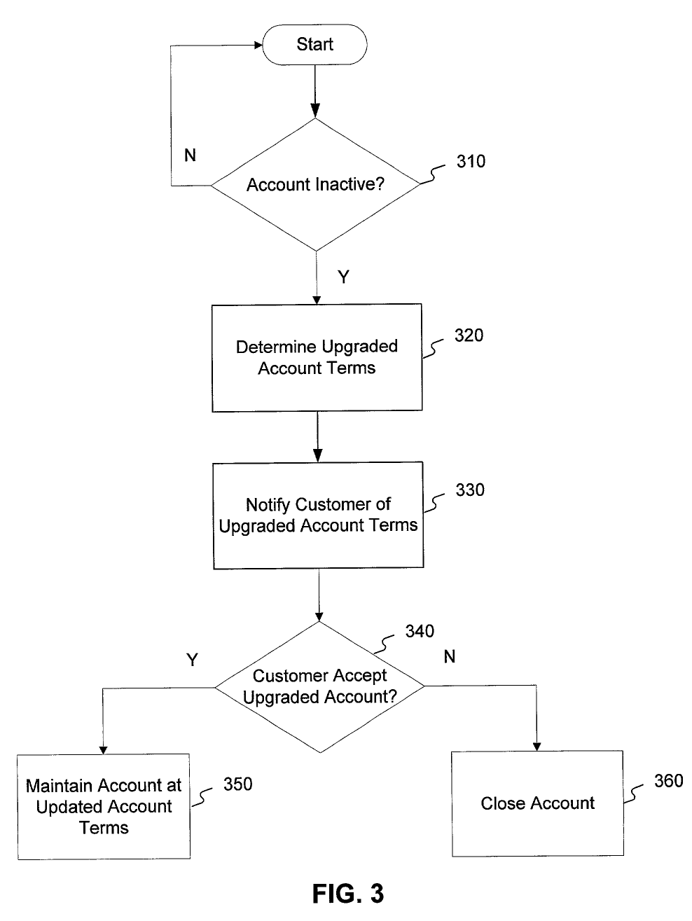

FIG. 3 illustrates an exemplary process, consistent with the present invention, for marketing to an existing customer of a financial account. The exemplary process of FIG. 3 may be performed using the exemplary system environment 100 of FIG. 1 and data stored, for example, according to the exemplary table 200 of FIG. 2.

As shown in FIG. 3, system 100 may begin by determining whether an account in table 200 is inactive (step 310). For instance, customer selection module 112 may determine which customer accounts are inactive based on the account balance and/or the number of account transactions of each account. Either or both of these account metrics may indicate the extent to which the particular customer uses the account.

For example, based on the data in column 204 of table 200, module 112 may monitor the number of payment cycles at which the billed account balance was at or below a minimum threshold value. The threshold value may be any monetary value that reflects the extent to which the corresponding customer uses the account. For instance, if the customer is a low income customer, the threshold value may be zero dollars. Any balance above this amount during a payment cycle (e.g., one month) may be typical for a low income customer. A zero balance, however, indicates the customer does not use the account. On the other hand, if the customer has a high income, then the minimum threshold value may be higher, such as $100. High income customers are likely to charge much more than this amount to their financial accounts during a typical payment cycle. For a wealthy customer, a billed balance that is typically at or below $100 may then indicate that the customer is not using the card as often as may be possible. The customer may be using cash or another financial account instead.

Alternatively, or additionally, selection module 112 may identify inactive accounts based on the number of account transactions made over a payment cycle represented by the data in column 206 of table 200. For example, module 112 may compare the number of account transactions to a corresponding minimum threshold value. If the number of transactions is at or below the threshold value, then system 100 may determine that the account is inactive. As described above, the threshold value may vary depending upon the type of customer.

Consistent with embodiments of the present invention, either the balance or transaction metric may be used to measure account inactivity by monitoring these metrics over a period of time. For instance, system 100 may require that the metric value be at or below the minimum threshold value for a number of continuous payment cycles (e.g., for 9 monthly payment cycles). Alternatively, system 100 may require that the metric be at or below the minimum threshold value for a certain number of payment cycles over a particular time period (e.g., for 10 monthly payment cycles over the last year). In one exemplary embodiment of the invention, module 112 determines that an account is inactive when the account balance is zero and the customer has made no transactions during the past nine months. Systems consistent with embodiments of the invention may use other types of account metrics, however, for determining whether an account is inactive.

Further, selection module 112 may base its decision to select a customer for an upgraded account term based on a determination that the customer has also been issued other competing financial accounts. System 100 may obtain this information, for example, from credit bureau 160. For example, column 208 of table 200 may identify whether a customer has another financial account, such as a credit card issued by another financial institution, as well as the number of such accounts. The existence of another account, as well as the number of such accounts, may indicate whether the account inactivity is due to the customer using another account. In such cases, selection module 112 may weigh the measured account metrics towards a finding of inactivity, since a customer known to have other competing cards is more likely to favorably respond to an upgraded account that competes better with those other accounts. Further, system 100 may update the information of column 208 when a weighted value of the account metrics of columns 204 or 206 indicate account inactivity. For instance, if the current value of column 208 causes the weighted data of either columns 204 or 206 to indicate the account is inactive, then system 100 may access credit bureau 160 to obtain updated information on the number of other financial accounts issued to the customer. Alternative embodiments may instead, however, update column 208 at other times.

In systems consistent with the present invention, module 112 may apply a variety of weighing functions to weight the data of either column 204 or 206 based on the number of other financial accounts indicated in column 208. For instance, module 112 may determine a weighted value of either account metric included in columns 204 or 206 based on a product of the number of other accounts and a weighing coefficient. For instance, module 112 may apply a weighing coefficient of 1.25 to the data of column 208. Thus if the customer has four other accounts, the weighted value is equal to (1.25)×4=5. Module 112 may then add the weighted value of 5 to the data of columns 204 or 206 to determine if they meet the minimum threshold value. Systems consistent with the present invention may use a variety of weighing coefficients, including, for example, 0.25, 1, or 3, the particular value of which may be determined by practicing routing skill in the art.

The exemplary accounts included in table 200 of FIG. 2 can be examined to further illustrate the decisioning logic of selection module 112. For example, account 212 shows that both the balance of the corresponding account and the number of account transactions have been below the corresponding threshold values for the last nine payment cycles and that the customer currently has one other active account. Assuming the predetermined time period for being below the threshold value is nine months in this example, then account 212 would be selected for upgrading since it has been inactive for nine months. Account 214 would not be selected, however, since its activity has not been below the minimum threshold level for any payment cycle over the predetermined time period. As to account 216, neither of its account metrics were below the threshold value for at least the predetermined time period of nine months. However, the customer associated with account 216 is indicated to have four other competing financial accounts. Module 112 may therefore apply a weighing function or weight factor to the account metrics of columns 204 and 206 to determine whether a revised finding of inactivity is warranted. Account 216 may likely be found inactive in this case since, for example, the weighted value for column 208 is (1.25)×(4)=5. Since the weighted value of column 206 is then 8+5=13, module 112 may then determine that the account is inactive since 13 is above the predetermined time period of nine in this example.

Returning to FIG. 3, once selection module 112 selects a customer as having an inactive account, upgraded account term generation module 114 then determines the upgraded account term(s) to offer that consumer (step 320). As described above, the account issuer may offer one or more upgraded account terms to encourage the customer to more frequently use the account. For a credit card account, the upgraded account terms may include, for example, a lower annual percentage rate (APR), a lower annual fee, and/or a higher credit limit. Other types of upgraded account terms may also be offered to encourage more frequent use, including, for example, platinum card status, increased reward points or frequent flyer miles for purchases, and/or other types of account features or options beneficial to the customer.

Upgraded account term generation module 114 may determine which upgraded account term(s) to offer based on the customer's credit rating and/or credit risk using risk analysis models known in the art. More particularly, module 114 determines one or more upgraded account terms that are commensurate with the customer's credit risk level and/or profit level for the account issuer, and that are more beneficial to the customer than the original account terms. By performing these analyses, module 114 may determine whether the customer qualifies for an upgraded account term, as well as the value or form of the upgraded account term.

System 100 then notifies the customer of the offer for the upgraded account term(s) (step 330). For instance, output module 130 may notify the customer over the phone, via e-mail, or by regular postal mail. The offer for the upgraded account term(s) may be made optional, requiring the consumer to accept the offer and provide notification of acceptance to the account issuer. Alternatively, in one embodiment, the term(s) may be extended automatically, in which case the notification states that the customer's account has been upgraded, including a description of the upgraded account term(s).

In one embodiment, the notification may inform the customer of the following: (1) that the account has been found inactive; (2) that to encourage the customer to use the account, the account issuer is offering the customer better or more beneficial account terms; and (3) that the customer can either accept the new terms and use the account, or do nothing and in which case the account will be closed. In another example, the notification may simply take the form of a “thank you” letter, in which account issuer states that because the customer has been a loyal customer, the issuer has automatically upgraded the customer's account with the better terms. In this later case, the intent is still to encourage the customer to more often use the account.

After notifying the customer of the upgraded account terms, system 100 may require the customer to affirmatively accept the upgraded terms (step 340). If the customer does accept the new account terms, then system 100 will manage the customer's account according to the new account terms (step 350). In one exemplary embodiment, system 100 may keep the upgraded account terms in effect for only a predetermined time period, such as for a six month period. At the expiration of this time period, the account terms may then revert back to their previous values. Alternatively, the upgraded account terms may become permanent terms associated with the customer's account. If, however, the account continues to remain inactive after upgrading the account, then system 100 may close the account. In one embodiment, the system would not close an account if the customer continues to use the account to at least some extent. Thus, for example, system 100 would not close an account in which the customer used only once per month, even though system 100 may have determined that the account was inactive (step 310), because the number of transactions was below a minimum threshold of transactions (such as a minimum of three transactions).

Referring again to FIG. 3, if the customer decides not to accept the upgraded account terms and/or requests for the account to be closed, then system 100 may close the account (step 360). Further, as an alternative to step 340, system 100 may simply notify the customer of the new account term(s) without requiring any response or acceptance from the customer. In such a case, system may then track whether the account remains inactive after its terms have been upgraded. If so, then system 100 may then close the account at that time. Again, however, an exemplary implementation of system 100 would not close an account when the customer uses the account to at least some extent.

The above-noted embodiments of the present invention may be implemented in various systems or network environments to provide automated computational tools for managing account records and performing tests to determine if various criteria are met. Such environments and applications may be specifically constructed for performing various processes and operations of the invention or they may include a general purpose computer or computing platform selectively activated or reconfigured by program code to provide the necessary functionality. The processes disclosed herein are not inherently related to any particular computer or apparatus, and may be implemented by a suitable combination of hardware, software, and/or firmware. For example, various general purpose machines may be used with programs written in accordance with the teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The media and program instructions may be those specially designed and constructed for the purposes of the invention, or they may be of the kind well-known and available to those having skill in the computer software arts. Examples of program instructions include both machine code, such as produced by a compiler, and files containing a high level code that can be executed by the computer using an interpreter.

It will be apparent to those skilled in the art that various modifications and variations can be made to the invention without departing from the scope or spirit of the invention. For example, modules 112 and 114 may be part of the same processing module and may be resident on a processor other than platform 110. Other modifications and embodiments of the invention will be apparent to those skilled in the art from consideration of the specification and practice of the invention disclosed herein. Therefore, it is intended that the specification and examples be considered as exemplary only, with a true scope and spirit of the invention being indicated by the following claims.

What is claimed is:

1. A method for marketing to an existing customer of a financial account, comprising:
determining whether the financial account of the customer is inactive;
if the account is inactive, generating at least one upgraded account term to present to the customer, wherein the financial account with the upgraded account term is more beneficial to the customer;
notifying the customer of the upgraded account term and thereby providing the customer with an incentive to more often use the financial account.

2. The method of claim 1, wherein determining whether an account is inactive comprises:
determining whether an account balance over a predetermined time period is below a threshold value.

3. The method of claim 2, wherein the account is determined to be inactive when the account balance for each payment cycle within the predetermined time period is below the threshold value.

4. The method of claim 2, wherein the account is determined to be inactive when the account balance for a predetermined number of payment cycles within the predetermined time period is below the threshold value.

5. The method of claim 1, wherein determining whether an account is inactive comprises:
determining whether a number of account transactions over a predetermined time period is below a threshold value.

6. The method of claim 5, wherein the account is determined to be inactive when the number of transactions for each payment cycle within the predetermined time period is below the threshold value.

7. The method of claim 5, wherein the account is determined to be inactive when the number of transactions for a predetermined number of payment cycles within the predetermined time period is below the threshold value.

8. The method of claim 1, wherein determining whether an account is inactive comprises:
determining whether the customer's use of the account is below a threshold value;
receiving credit information associated with the customer to determine whether the customer is an account holder for another financial account; and
determining that the account is inactive when the customer's use of the account is below a threshold value and the customer is determined to be the holder of another financial account.

9. The method of claim 1, wherein determining that the account is inactive further includes:
determining whether the account is inactive based on an account metric, wherein the account metric is based on at least one of an account balance and a number of account transactions;
weighing the account metric based on a number of other financial accounts held by the customer; and
determining that the account is inactive when the weighted account metric exceeds a threshold value.

10. The method of claim 1, wherein notifying the customer further includes:
notifying the customer of the upgraded account term by at least one e-mail, regular mail, and telephone.

11. The method of claim 1, further including:
closing the account if, after upgrading the account, the account remains inactive.

12. The method of claim 1, further including:
returning the account terms to terms existing prior to the upgrading after a predetermined time period has elapsed since the account term was upgraded.

13. A system for marketing to an existing customer of a financial account, comprising:
means for determining whether the financial account of the customer is inactive;
if the account is inactive, means for generating at least one upgraded account term to present to the customer, wherein the financial account with the upgraded account term is more beneficial to the customer;
means for notifying the customer of the upgraded account term and thereby providing the customer with an incentive to more often use the financial account.

14. The system of claim 13, wherein the means for determining whether an account is inactive comprises:
means for determining whether an account balance over a predetermined time period is below a threshold value.

15. The system of claim 14, wherein the account is determined to be inactive when the account balance for each payment cycle within the predetermined time period is below the threshold value.

16. The system of claim 14, wherein the account is determined to be inactive when the account balance for a predetermined number of payment cycles within the predetermined time period is below the threshold value.

17. The system of claim 13, wherein the means for determining whether an account is inactive comprises:
means for determining whether a number of account transactions over a predetermined time period is below a threshold value.

18. The system of claim 17, wherein the account is determined to be inactive when the number of transactions for each payment cycle within the predetermined time period is below the threshold value.

19. The system of claim 17, wherein the account is determined to be inactive when the number of transactions for a predetermined number of payment cycles within the predetermined time period is below the threshold value.

20. The system of claim 13, wherein the means for determining whether an account is inactive comprises:
means for determining whether the customer's use of the account is below a threshold value;
means for receiving credit information associated with the customer to determine whether the customer is an account holder for another financial account; and
means for determining that the account is inactive when the customer's use of the account is below a threshold value and the customer is determined to be the holder of another financial account.

21. The system of claim 13, wherein the means for determining that the account is inactive further includes:
means for determining whether the account is inactive based on an account metric, wherein the account metric is based on at least one of an account balance and a number of account transactions;
means for weighing the account metric based on a number of other financial accounts held by the customer; and
means for determining that the account is inactive when the weighted account metric exceeds a threshold value.

22. The system of claim 13, wherein the means for notifying the customer further includes:
means for notifying the customer of the upgraded account term by at least one e-mail, regular mail, and telephone.

23. The system of claim 13, further including:
means for closing the account if, after upgrading the account, the account remains inactive.

24. The system of claim 13, further including:
means for returning the account terms to terms existing prior to the upgrading after a predetermined time period has elapsed since the account term was upgraded.
